(19) United States
(12) Patent Application Publication
(10) Pub. No.: US 2006/0180098 A1
(43) Pub. Date: Aug. 17, 2006

(54) Elbow pads for dogs

(76) Inventors: Allen Yung, West Covina, CA (US); Andrea Fong, West Covina, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/326,811

(22) Filed: Jan. 6, 2006

Related U.S. Application Data
(60) Provisional application No. 60/642,469, filed on Jan. 6, 2005.

(51) Int. Cl. A01K 13/00

(52) U.S. Cl. 119/850

(57) ABSTRACT

An apparatus to protect a dog's elbows. The apparatus has a left sleeve to slide on a dog's left leg and a right sleeve to slid eon a dog's right leg. The sleeves are connected by a strap which has a hollow portion wherein the dog's collar can be inserted therein.

### CROSS REFERENCE TO RELATED APPLICATIONS

The application claims benefit to provisional application 60/642,469, filed on Jan. 6, 2005, entitled “ELBOW PADS FOR DOGS,” which is incorporated herein in its entirety.

### BACKGROUND OF THE INVENTION

1. Field of the Invention

The present invention is directed to a method and apparatus to provide elbow protection for dogs.

2. Description of the Related Art

U.S. Pat. No. 5,463,985, to Shover, is directed towards protective apparel worn by animals, such as female dogs, for protecting the surrounding environment from body secretions, such as when the animal is in heat, having an absorption pad supported by a removable panel that eliminates the need for removing the garment when the animal has to relieve itself and elastic-type bands sewn in at the neck, waist, and legs to restrain the garment and to prevent its easy removal by the animal.

U.S. Pat. No. 4,612,925, to Bender, is directed towards a veterinary medical leg splint suitable for cat and dog restraint prevents an animal from flexing its elbow joint and effectively shutting off the flow of intravenous fluids. After placing an intravenous catheter in place in an animal foreleg in a cephalic vein, the cat and dog intravenous restraint splint is applied typically to the foreleg of the animal. The basic restraint is a washable, reusable, gas sterilizable longitudinal plastic restraint that can have two Velcro straps for attachment to a leg. The splint device has a one piece rigid strip having a longitudinal slit aperture adjacent the first splint terminus. The first of the two leg restraint straps is adjustably slidable in the longitudinal slit aperture, secured normal in the aperture by a restraint pin. The second splint terminus has an adjacent paddle shaped terminal piece secured normal to the rigid strip. The second of the leg straps is secured normal to the splint adjacent to the paddle. A horizontal slot is also disposed across the splint at the first splint terminus.

However, what is needed is an apparatus to protect a dog's front legs.

### SUMMARY OF THE INVENTION

It is an aspect of the present invention to provide a protective pad for dogs. The present general inventive concept will protect the dog's elbows against calluses and cysts from the normal use of laying down.

The above aspects can also be obtained by an apparatus that includes (a) a left sleeve and a right sleeve adapted to receive a dog's left leg and right leg, respectively, the left sleeve and the right sleeve connected by a strap; and (b) a collar connector connected to the strap to receive a dog's collar.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is drawing of a back view of an apparatus, according to an embodiment;

FIG. 2 is a drawing of a side view of an apparatus, according to an embodiment;

FIG. 3 is a drawing of a front view of an apparatus, according to an embodiment;

FIG. 4 is a first perspective view of the apparatus partially attached to a dog, according to an embodiment;

FIG. 5 is a second perspective view of the apparatus partially attached to a dog, according to an embodiment; and

FIG. 6 if a front view of the apparatus attached to a dog, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to a method and apparatus to provide protection for a dog's front legs or elbows. Protective sleeves are provided for that a dog's paws can be inserted thereto. The sleeves can be attached to a dog around the dog's collar. The apparatus can be made from any material, such as cloth.

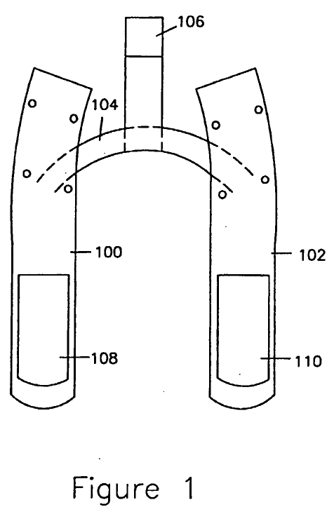

FIG. 1 is drawing of a back view of an apparatus, according to an embodiment.

A left sleeve 100 and a right sleeve 112 are used to insert the dog's paws/legs into. The sleeves are hollow, similar to a pants leg for a dog. A left pad 108 and a right pad 110 can be used to cushion the dog's elbows. The pads can be attached to the sleeves at a place where the dog's elbow joints may be. The pads can be external to the sleeve or inside. A strap 104 is used to connect the left sleeve 100 and the right sleeve 112. A collar attachment 106 is used to attach to the dog's collar, thereby securing the apparatus to the dog.

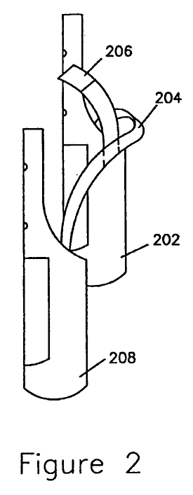

FIG. 2 is a drawing of a side view of an apparatus, according to an embodiment.

A left sleeve 208 and a right sleeve 202 are connected via a strap 204. A collar attachment 206 is used to receive the dog's collar.

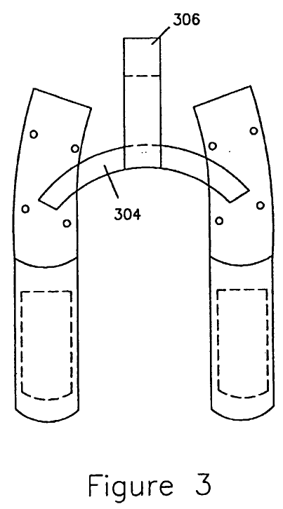

FIG. 3 is a drawing of a front view of an apparatus, according to an embodiment.

A strap 304 is used to attached the two sleeves of the apparatus. The collar attachment 306 is used to receive the dog's collar (e.g. the collar is inserted through the collar attachment 306).

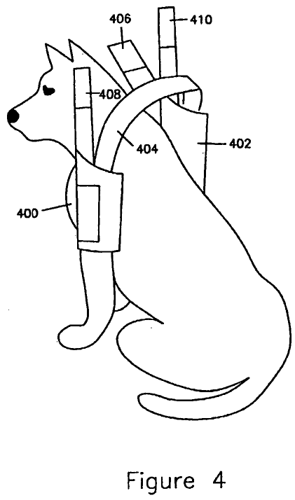

FIG. 4 is a first perspective view of the apparatus partially attached to a dog, according to an embodiment.

A dog 400 has his right leg inserted into the right sleeve 402 and the left leg inserted into the left sleeve. A strap connects the left sleeve and the right sleeve 402. A left leg loop 408 is above the left sleeve, and a right leg loop 410 is above the right sleeve. The left leg loop 408 and the right leg loop 410 are used to receive the collar.

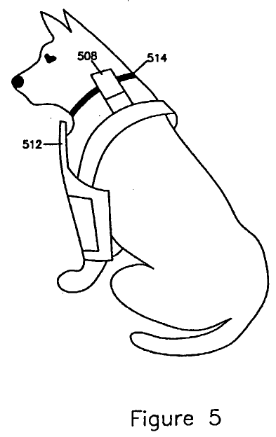

FIG. 5 is a second perspective view of the apparatus partially attached to a dog, according to an embodiment.

The dog's collar 514 is inserted through the collar attachment 508. The collar attachment 508 is a hollow portion which is adapted so that a collar can be inserted therein. The collar 514 can also be inserted through the left leg loop 512 and the right leg loop (not pictured in FIG. 5).

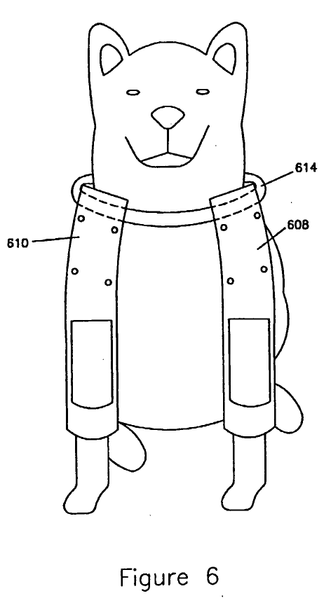

FIG. 6 if a front view of the apparatus attached to a dog, according to an embodiment.

The collar 614 is inserted through the left leg loop 608 and the right leg loop 610. The collar 614 is also inserted through the collar attachment (not pictured). Thus, the collar, goes through three parts of the present apparatus (the left leg loop, the right leg loop, and the collar attachment) in order to secure the apparatus to the dog.

It is noted that the sides of the sleeves (e.g. the left side and the right side) can also be padded to provide further comfort for the dog when the dog rests on his paws.

As can be seen by the above-described figures, a dog can comfortably wear the apparatus yet be protected from calluses and cysts.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A protective apparatus for dogs, the apparatus comprising:
a left sleeve and a right sleeve adapted to receive a dog's left leg and right leg, respectively, the left sleeve and the right sleeve connected by a strap; and
a collar connector connected to the strap to receive a dog's collar.

2. An apparatus as recited in claim 1, further comprising:
a left pad on the left sleeve; and
a right pad on the right sleeve.
